(19) United States
(12) Patent Application Publication
(10) Pub. No.: US 2024/0110717 A1
(43) Pub. Date: Apr. 4, 2024

(54) BUILDING SYSTEM WITH OCCUPANCY PREDICTION AND DEEP LEARNING MODELING OF AIR QUALITY AND INFECTION RISK

(71) Applicant: Johnson Controls Tyco IP Holdings LLP, Milwaukee, WI (US)

(72) Inventors: Chenlu Zhang, Milwaukee, WI (US); Young M. Lee, Old Westbury, NY (US); Zhanhong Jiang, Milwaukee, WI (US)

(21) Appl. No.: 18/371,220

(22) Filed: Sep. 21, 2023

Related U.S. Application Data
(60) Provisional application No. 63/411,864, filed on Sep. 30, 2022.

(51) Int. Cl. F24F 11/64

(52) U.S. Cl. CPC F24F 11/64; F24F 2130/10

(57) ABSTRACT

A method for controlling building equipment includes providing an occupancy prediction for a building using an occupancy prediction model that uses both historical values and forecast values of an environmental condition as inputs. The method also includes controlling the building equipment based on the occupancy prediction.

### CROSS-REFERENCE WITH RELATED APPLICATIONS

This application claims the benefit of and priority to U.S. Provisional Patent Application No. 63/411,864 filed Sep. 30, 2022, the entire disclosure of which is incorporated by reference herein.

### BACKGROUND

The present disclosure relates generally to the field of building management systems (BMSs). A BMS is, in general, a system of devices configured to control, monitor, and manage equipment in or around a building. A BMS can include, for example, a HVAC system, a security system, a lighting system, a fire alerting system, any other system that is capable of managing building functions or devices, or any combination thereof. Equipment, spaces, and points associated with the BMS can be represented as objects in a BMS configuration dataset. To facilitate user interaction with a BMS, it may be desirable to map BMS objects to an ontology data model such that the BMS objects and object relationships are described in a semantic or natural manner.

### SUMMARY

One implementation of the present disclosure is a method for controlling building equipment. The method includes providing an occupancy prediction for a building using an occupancy prediction model that uses both historical values and forecast values of an environmental condition as inputs and controlling the building equipment based on the occupancy prediction.

In some embodiments, providing the occupancy prediction includes generating, by a first set of neural network models, an encoder state based on historical timeseries data of occupancy and the environmental condition as inputs, and generating, by a second set of neural network models, the occupancy prediction based on the encoder state and a forecast timeseries for the environmental condition. The first set of neural network models may include a first LSTM model configured to use values from a first historical timestep of the historical timeseries data as an input and a second LSTM model configured to use an output of the first LSTM model and values from a second historical timestep of the historical timeseries data as inputs, the second historical timestep after the first historical timestep. The second set of neural network models may include a third LSTM model configured to use the encoder state and a first forecast value of the environmental condition corresponding to a first future timestep an input and a fourth LSTM model configured to use an output of the third LSTM model and a second forecast value of the environmental condition corresponding to a second future timestep as an input. The second future timestep is after the first future timestep. The third LSTM model may output the occupancy prediction for the first future timestep and the fourth LSTM model may output the occupancy prediction for the second future timestep.

In some embodiments, providing the occupancy prediction includes using a first value of the occupancy prediction to generate an infection risk estimate for the building and using the infection risk estimate to generate a second value of the occupancy prediction.

In some embodiments, the environmental condition is a particulate matter concentration or air quality index. In some embodiments, the environmental condition is precipitation. The occupancy predication may include a timeseries of predicted occupancy values for a plurality of time steps of an upcoming time period.

Controlling the building equipment based on the occupancy prediction can include classifying a time period into a classification based on the occupancy prediction, selecting control settings based on the classification, and controlling the building equipment using the control settings. In some embodiments, controlling the building equipment based on the occupancy prediction includes using the occupancy prediction as an input to a predictive building model and generating a setpoint for the building equipment by performing an optimization using the predictive building model.

Another implementation of the present disclosure is one or more non-transitory computer-readable media storing instructions that, when executed by one or more processors, cause the one or more processors to perform operations. The operations include predicting a future occupancy of a space by using forecasted values relating to infection risk and weather as inputs to an occupancy model and controlling building equipment to affect heating, ventilation, or cooling of the space based on the future occupancy of the space.

In some embodiments, the occupancy model comprises a plurality of artificial neural networks. The occupancy model may include a long short-term memory network and may have an encoder-decoder architecture. In some embodiments, the operations include comprising using historical occupancy measurements as inputs to the occupancy model. In some embodiments, predicting the future occupancy of the space also includes using information indicative of an event occurring external to the space.

In some embodiments, the method includes training the occupancy model on historical occupancy data, infection risk history, and weather measurements. Controlling building equipment based on the future occupancy of the space can include determining a classification of a time period as occupied or unoccupied based on the future occupancy and selecting a setting for the building equipment based on the classification.

In some embodiments, controlling the building equipment based on the future occupancy of the space comprises applying the future occupancy as an input to a building model and using the building model for model predictive control. In some embodiments, the forecasted values relating to weather are indicative of precipitation or air quality index

One embodiment of the present disclosure is a method for controlling building equipment. The method includes providing an occupancy prediction for a space based on a forecast of an external environmental condition and controlling the building equipment based on the occupancy prediction.

In some embodiments, providing the occupancy prediction is also based on an infection risk. In some embodiments, the external environmental condition is outdoor air quality. In some embodiments, the external environmental condition is a precipitation forecast. In some embodiments, wherein the external environmental condition is associated with occurrence of an event.

In some embodiments, providing the occupancy prediction for the space includes applying the external environmental condition as an input to a machine learning model. The method may include training the machine learning model based on training data comprising occupancy measurements and historical values of the external environmental condition.

In some embodiments, the occupancy prediction indicates whether the space will be occupied or unoccupied. In some embodiments, the occupancy prediction indicates a number of occupants. In some embodiments, the occupancy predication comprises a timeseries of predicted occupancy values for a plurality of time steps of an upcoming time period.

In some embodiments, controlling the building equipment based on the occupancy prediction includes selecting a building status based on the occupancy prediction. The building status may be associated with a setpoint for the building equipment. In some embodiments, controlling the building equipment based on the occupancy prediction includes using the occupancy prediction as an input to a predictive building model and generating a setpoint for the building equipment by performing an optimization using the predictive building model.

Another implementation of the present disclosure is one or more non-transitory computer-readable media storing instructions that, when executed by one or more processors, cause the one or more processors to perform operations. The operations may include predicting a future occupancy of a space by using forecasted values of infection risk and weather as inputs to an occupancy model and controlling building equipment to affect heating, ventilation, or cooling of the space based on the future occupancy of the space.

In some embodiments, the occupancy model includes an artificial neural network. In some embodiments, the occupancy model comprises a plurality of long short-term memory networks.

In some embodiments, predicting the future occupancy of the space also includes using information indicative of an event occurring external to the space. In some embodiments, the method includes training the occupancy model on historical occupancy data, infection risk history, and weather measurements.

In some embodiments, controlling building equipment based on the future occupancy of the space includes determining a classification of a time period as occupied or unoccupied based on the future occupancy and selecting a setting for the building equipment based on the classification.

In some embodiments, controlling the building equipment based on the future occupancy of the space includes applying the future occupancy as an input to a building model and using the building model for model predictive control.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is a drawing of a building equipped with a HVAC system, according to some embodiments.

FIG. 2 is a block diagram of a waterside system that may be used in conjunction with the building of FIG. 1, according to some embodiments.

FIG. 3 is a block diagram of an airside system that may be used in conjunction with the building of FIG. 1, according to some embodiments.

FIG. 4 is a block diagram of a building management system (BMS) that may be used to monitor and/or control the building of FIG. 1, according to some embodiments.

FIG. 5 is a block diagram of another BMS which can be used to monitor and control the building of FIG. 1, according to some embodiments.

FIG. 6 is a block diagram of a BMS enabled to predict occupancy and control building equipment based on occupancy predictions, according to some embodiments.

FIG. 7 is an illustration of an occupancy model, according to some embodiments.

FIG. 8 is a flowchart of a process for operating equipment based on an occupancy prediction, according to some embodiments.

FIG. 9 is a flowchart of another process for operating equipment based on an occupancy prediction, according to some embodiments.

### DETAILED DESCRIPTION

### Building HVAC Systems and Building Management Systems

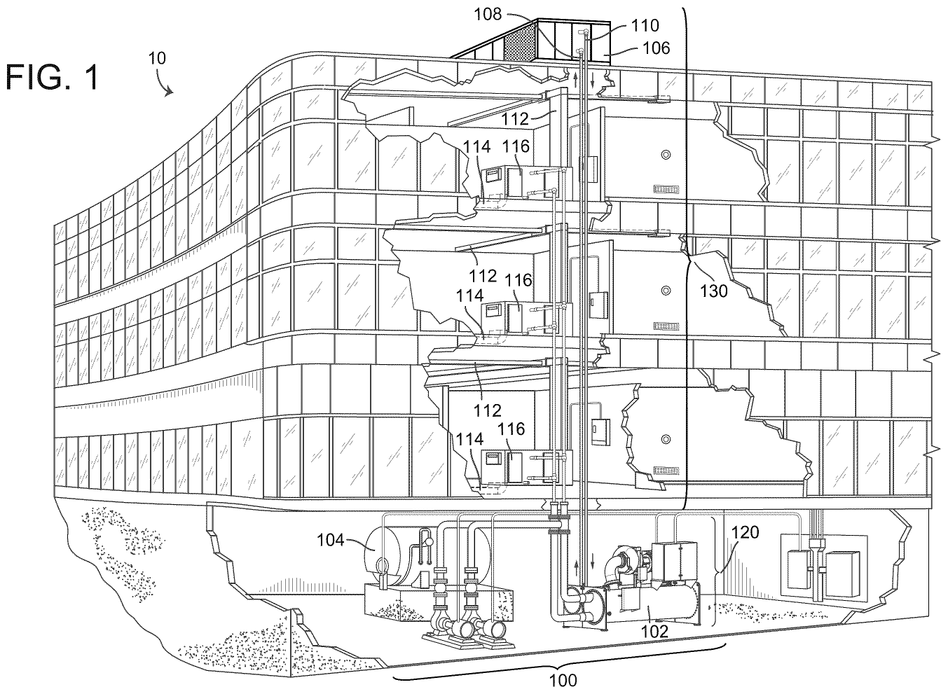

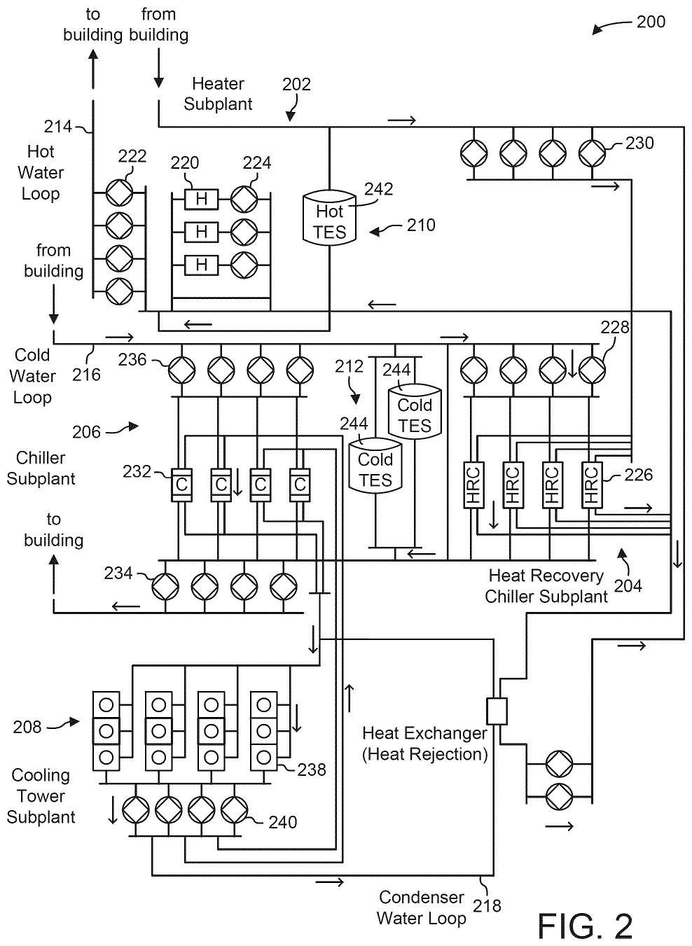

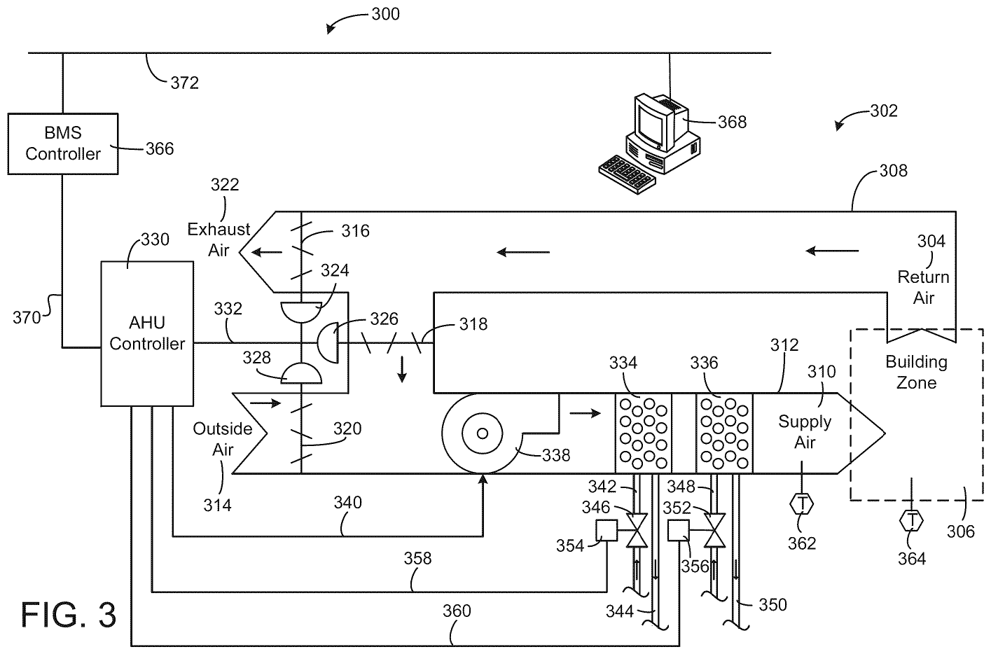

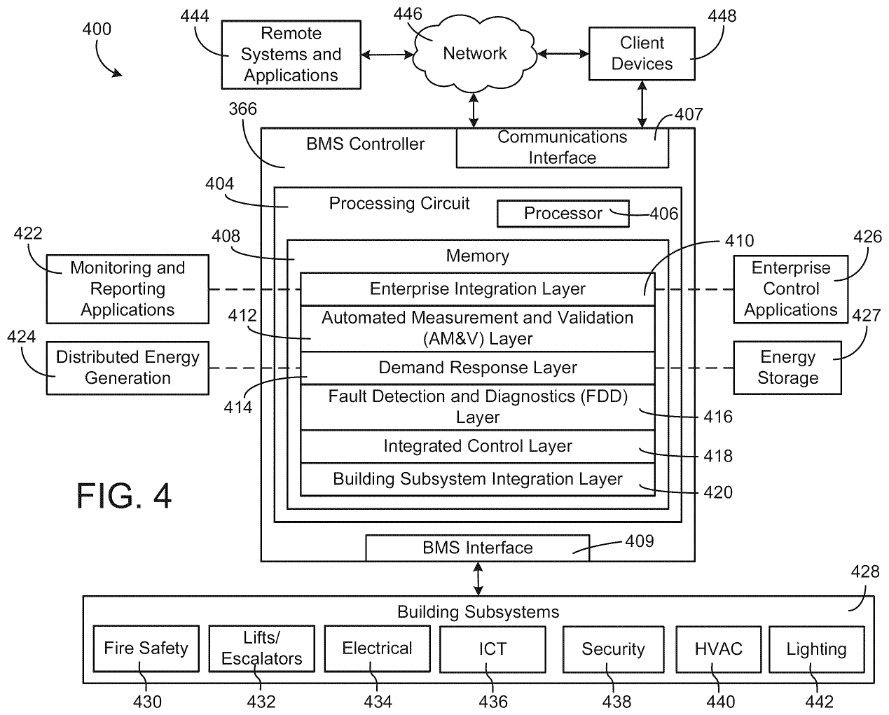

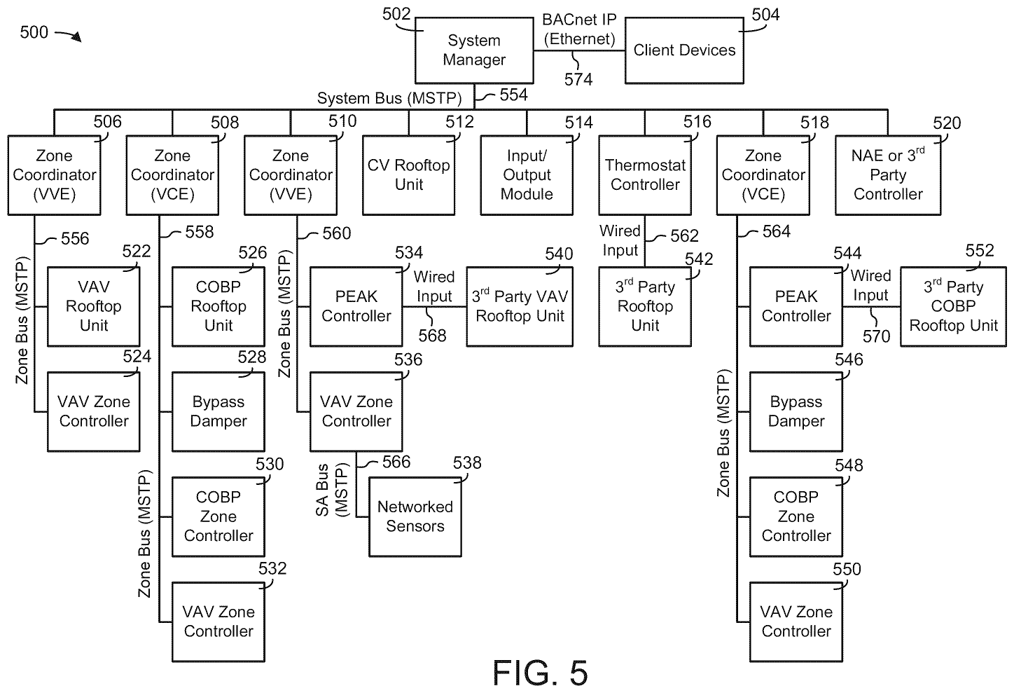

Referring now to FIGS. 1-5, several building management systems (BMS) and HVAC systems in which the systems and methods of the present disclosure can be implemented are shown, according to some embodiments. In brief overview, FIG. 1 shows a building 10 equipped with a HVAC system 100. FIG. 2 is a block diagram of a waterside system 200 which can be used to serve building 10. FIG. 3 is a block diagram of an airside system 300 which can be used to serve building 10. FIG. 4 is a block diagram of a BMS which can be used to monitor and control building 10. FIG. 5 is a block diagram of another BMS which can be used to monitor and control building 10.

Referring particularly to FIG. 1, a perspective view of a building 10 is shown. Building 10 is served by a BMS. A BMS is, in general, a system of devices configured to control, monitor, and manage equipment in or around a building or building area. A BMS can include, for example, a HVAC system, a security system, a lighting system, a fire safety system, any other system that is capable of managing building functions or devices, or any combination thereof.

The BMS that serves building 10 includes an HVAC system 100. HVAC system 100 can include a plurality of HVAC devices (e.g., heaters, chillers, air handling units, pumps, fans, thermal energy storage, etc.) configured to provide heating, cooling, ventilation, or other services for building 10. For example, HVAC system 100 is shown to include a waterside system 120 and an airside system 130. Waterside system 120 can provide a heated or chilled fluid to an air handling unit of airside system 130. Airside system 130 can use the heated or chilled fluid to heat or cool an airflow provided to building 10. An exemplary waterside system and airside system which can be used in HVAC system 100 are described in greater detail with reference to FIGS. 2-3.

HVAC system 100 is shown to include a chiller 102, a boiler 104, and a rooftop air handling unit (AHU) 106. Waterside system 120 can use boiler 104 and chiller 102 to heat or cool a working fluid (e.g., water, glycol, etc.) and can circulate the working fluid to AHU 106. In various embodiments, the HVAC devices of waterside system 120 can be located in or around building 10 (as shown in FIG. 1) or at an offsite location such as a central plant (e.g., a chiller plant, a steam plant, a heat plant, etc.). The working fluid can be heated in boiler 104 or cooled in chiller 102, depending on whether heating or cooling is required in building 10. Boiler 104 can add heat to the circulated fluid, for example, by burning a combustible material (e.g., natural gas) or using an electric heating element. Chiller 102 can place the circulated fluid in a heat exchange relationship with another fluid (e.g., a refrigerant) in a heat exchanger (e.g., an evaporator) to absorb heat from the circulated fluid. The working fluid from chiller 102 and/or boiler 104 can be transported to AHU 106 via piping 108.

AHU 106 can place the working fluid in a heat exchange relationship with an airflow passing through AHU 106 (e.g., via one or more stages of cooling coils and/or heating coils). The airflow can be, for example, outside air, return air from within building 10, or a combination of both. AHU 106 can transfer heat between the airflow and the working fluid to provide heating or cooling for the airflow. For example, AHU 106 can include one or more fans or blowers configured to pass the airflow over or through a heat exchanger containing the working fluid. The working fluid can then return to chiller 102 or boiler 104 via piping 110.

Airside system 130 can deliver the airflow supplied by AHU 106 (i.e., the supply airflow) to building 10 via air supply ducts 112 and can provide return air from building 10 to AHU 106 via air return ducts 114. In some embodiments, airside system 130 includes multiple variable air volume (VAV) units 116. For example, airside system 130 is shown to include a separate VAV unit 116 on each floor or zone of building 10. VAV units 116 can include dampers or other flow control elements that can be operated to control an amount of the supply airflow provided to individual zones of building 10. In other embodiments, airside system 130 delivers the supply airflow into one or more zones of building 10 (e.g., via supply ducts 112) without using intermediate VAV units 116 or other flow control elements. AHU 106 can include various sensors (e.g., temperature sensors, pressure sensors, etc.) configured to measure attributes of the supply airflow. AHU 106 can receive input from sensors located within AHU 106 and/or within the building zone and can adjust the flow rate, temperature, or other attributes of the supply airflow through AHU 106 to achieve setpoint conditions for the building zone.

In FIG. 2, waterside system 200 is shown as a central plant having a plurality of subplants 202-212. Subplants 202-212 are shown to include a heater subplant 202, a heat recovery chiller subplant 204, a chiller subplant 206, a cooling tower subplant 208, a hot thermal energy storage (TES) subplant 210, and a cold thermal energy storage (TES) subplant 212. Subplants 202-212 consume resources (e.g., water, natural gas, electricity, etc.) from utilities to serve the thermal energy loads (e.g., hot water, cold water, heating, cooling, etc.) of a building or campus. For example, heater subplant 202 may be configured to heat water in a hot water loop 214 that circulates the hot water between heater subplant 202 and building 10. Chiller subplant 206 may be configured to chill water in a cold water loop 216 that circulates the cold water between chiller subplant 206 building 10. Heat recovery chiller subplant 204 may be configured to transfer heat from cold water loop 216 to hot water loop 214 to provide additional heating for the hot water and additional cooling for the cold water. Condenser water loop 218 may absorb heat from the cold water in chiller subplant 206 and reject the absorbed heat in cooling tower subplant 208 or transfer the absorbed heat to hot water loop 214. Hot TES subplant 210 and cold TES subplant 212 may store hot and cold thermal energy, respectively, for subsequent use.

Hot water loop 214 and cold water loop 216 may deliver the heated and/or chilled water to air handlers located on the rooftop of building 10 (e.g., AHU 106) or to individual floors or zones of building 10 (e.g., VAV units 116). The air handlers push air past heat exchangers (e.g., heating coils or cooling coils) through which the water flows to provide heating or cooling for the air. The heated or cooled air may be delivered to individual zones of building 10 to serve the thermal energy loads of building 10. The water then returns to subplants 202-212 to receive further heating or cooling.

Although subplants 202-212 are shown and described as heating and cooling water for circulation to a building, it is understood that any other type of working fluid (e.g., glycol, CO2, etc.) may be used in place of or in addition to water to serve the thermal energy loads. In other embodiments, subplants 202-212 may provide heating and/or cooling directly to the building or campus without requiring an intermediate heat transfer fluid. These and other variations to waterside system 200 are within the teachings of the present invention.

Each of subplants 202-212 may include a variety of equipment configured to facilitate the functions of the subplant. For example, heater subplant 202 is shown to include a plurality of heating elements 220 (e.g., boilers, electric heaters, etc.) configured to add heat to the hot water in hot water loop 214. Heater subplant 202 is also shown to include several pumps 222 and 224 configured to circulate the hot water in hot water loop 214 and to control the flow rate of the hot water through individual heating elements 220. Chiller subplant 206 is shown to include a plurality of chillers 232 configured to remove heat from the cold water in cold water loop 216. Chiller subplant 206 is also shown to include several pumps 234 and 236 configured to circulate the cold water in cold water loop 216 and to control the flow rate of the cold water through individual chillers 232.

Heat recovery chiller subplant 204 is shown to include a plurality of heat recovery heat exchangers 226 (e.g., refrigeration circuits) configured to transfer heat from cold water loop 216 to hot water loop 214. Heat recovery chiller subplant 204 is also shown to include several pumps 228 and 230 configured to circulate the hot water and/or cold water through heat recovery heat exchangers 226 and to control the flow rate of the water through individual heat recovery heat exchangers 226. Cooling tower subplant 208 is shown to include a plurality of cooling towers 238 configured to remove heat from the condenser water in condenser water loop 218. Cooling tower subplant 208 is also shown to include several pumps 240 configured to circulate the condenser water in condenser water loop 218 and to control the flow rate of the condenser water through individual cooling towers 238.

Hot TES subplant 210 is shown to include a hot TES tank 242 configured to store the hot water for later use. Hot TES subplant 210 may also include one or more pumps or valves configured to control the flow rate of the hot water into or out of hot TES tank 242. Cold TES subplant 212 is shown to include cold TES tanks 244 configured to store the cold water for later use. Cold TES subplant 212 may also include one or more pumps or valves configured to control the flow rate of the cold water into or out of cold TES tanks 244.

In some embodiments, one or more of the pumps in waterside system 200 (e.g., pumps 222, 224, 228, 230, 234, 236, and/or 240) or pipelines in waterside system 200 include an isolation valve associated therewith. Isolation valves may be integrated with the pumps or positioned upstream or downstream of the pumps to control the fluid flows in waterside system 200. In various embodiments, waterside system 200 may include more, fewer, or different types of devices and/or subplants Based on the particular configuration of waterside system 200 and the types of loads served by waterside system 200.

Referring now to FIG. 3, a block diagram of an airside system 300 is shown, according to some embodiments. In various embodiments, airside system 300 may supplement or replace airside system 130 in HVAC system 100 or may be implemented separate from HVAC system 100. When implemented in HVAC system 100, airside system 300 may include a subset of the HVAC devices in HVAC system 100 (e.g., AHU 106, VAV units 116, ducts 112-114, fans, dampers, etc.) and may be located in or around building 10. Airside system 300 may operate to heat or cool an airflow provided to building 10 using a heated or chilled fluid provided by waterside system 200.

In FIG. 3, airside system 300 is shown to include an economizer-type air handling unit (AHU) 302. Economizer-type AHUs vary the amount of outside air and return air used by the air handling unit for heating or cooling. For example, AHU 302 may receive return air 304 from building zone 306 via return air duct 308 and may deliver supply air 310 to building zone 306 via supply air duct 312. In some embodiments, AHU 302 is a rooftop unit located on the roof of building 10 (e.g., AHU 106 as shown in FIG. 1) or otherwise positioned to receive both return air 304 and outside air 314. AHU 302 may be configured to operate exhaust air damper 316, mixing damper 318, and outside air damper 320 to control an amount of outside air 314 and return air 304 that combine to form supply air 310. Any return air 304 that does not pass through mixing damper 318 may be exhausted from AHU 302 through exhaust damper 316 as exhaust air 322.

Each of dampers 316-320 may be operated by an actuator. For example, exhaust air damper 316 may be operated by actuator 324, mixing damper 318 may be operated by actuator 326, and outside air damper 320 may be operated by actuator 328. Actuators 324-328 may communicate with an AHU controller 330 via a communications link 332. Actuators 324-328 may receive control signals from AHU controller 330 and may provide feedback signals to AHU controller 330. Feedback signals may include, for example, an indication of a current actuator or damper position, an amount of torque or force exerted by the actuator, diagnostic information (e.g., results of diagnostic tests performed by actuators 324-328), status information, commissioning information, configuration settings, calibration data, and/or other types of information or data that may be collected, stored, or used by actuators 324-328. AHU controller 330 may be an economizer controller configured to use one or more control algorithms (e.g., state-Based algorithms, extremum seeking control (ESC) algorithms, proportional-integral (PI) control algorithms, proportional-integral-derivative (PID) control algorithms, model predictive control (MPC) algorithms, feedback control algorithms, etc.) to control actuators 324-328.

Still referring to FIG. 3, AHU 302 is shown to include a cooling coil 334, a heating coil 336, and a fan 338 positioned within supply air duct 312. Fan 338 may be configured to force supply air 310 through cooling coil 334 and/or heating coil 336 and provide supply air 310 to building zone 306. AHU controller 330 may communicate with fan 338 via communications link 340 to control a flow rate of supply air 310. In some embodiments, AHU controller 330 controls an amount of heating or cooling applied to supply air 310 by modulating a speed of fan 338.

Cooling coil 334 may receive a chilled fluid from waterside system 200 (e.g., from cold water loop 216) via piping 342 and may return the chilled fluid to waterside system 200 via piping 344. Valve 346 may be positioned along piping 342 or piping 344 to control a flow rate of the chilled fluid through cooling coil 334. In some embodiments, cooling coil 334 includes multiple stages of cooling coils that can be independently activated and deactivated (e.g., by AHU controller 330, by BMS controller 366, etc.) to modulate an amount of cooling applied to supply air 310.

Heating coil 336 may receive a heated fluid from waterside system 200 (e.g., from hot water loop 214) via piping 348 and may return the heated fluid to waterside system 200 via piping 350. Valve 352 may be positioned along piping 348 or piping 350 to control a flow rate of the heated fluid through heating coil 336. In some embodiments, heating coil 336 includes multiple stages of heating coils that can be independently activated and deactivated (e.g., by AHU controller 330, by BMS controller 366, etc.) to modulate an amount of heating applied to supply air 310.

Each of valves 346 and 352 may be controlled by an actuator. For example, valve 346 may be controlled by actuator 354 and valve 352 may be controlled by actuator 356. Actuators 354-356 may communicate with AHU controller 330 via communications links 358-360. Actuators 354-356 may receive control signals from AHU controller 330 and may provide feedback signals to controller 330. In some embodiments, AHU controller 330 receives a measurement of the supply air temperature from a temperature sensor 362 positioned in supply air duct 312 (e.g., downstream of cooling coil 334 and/or heating coil 336). AHU controller 330 may also receive a measurement of the temperature of building zone 306 from a temperature sensor 364 located in building zone 306.

In some embodiments, AHU controller 330 operates valves 346 and 352 via actuators 354-356 to modulate an amount of heating or cooling provided to supply air 310 (e.g., to achieve a setpoint temperature for supply air 310 or to maintain the temperature of supply air 310 within a setpoint temperature range). The positions of valves 346 and 352 affect the amount of heating or cooling provided to supply air 310 by cooling coil 334 or heating coil 336 and may correlate with the amount of energy consumed to achieve a desired supply air temperature. AHU controller 330 may control the temperature of supply air 310 and/or building zone 306 by activating or deactivating coils 334-336, adjusting a speed of fan 338, or a combination of both.

Still referring to FIG. 3, airside system 300 is shown to include a building management system (BMS) controller 366 and a client device 368. BMS controller 366 may include one or more computer systems (e.g., servers, supervisory controllers, subsystem controllers, etc.) that serve as system level controllers, application or data servers, head nodes, or master controllers for airside system 300, waterside system 200, HVAC system 100, and/or other controllable systems that serve building 10. BMS controller 366 may communicate with multiple downstream building systems or subsystems (e.g., HVAC system 100, a security system, a lighting system, waterside system 200, etc.) via a communications link 370 according to like or disparate protocols (e.g., LON, BACnet, etc.). In various embodiments, AHU controller 330 and BMS controller 366 may be separate (as shown in FIG. 3) or integrated. In an integrated implementation, AHU controller 330 may be a software module configured for execution by a processor of BMS controller 366.

In some embodiments, AHU controller 330 receives information from BMS controller 366 (e.g., commands, setpoints, operating boundaries, etc.) and provides information to BMS controller 366 (e.g., temperature measurements, valve or actuator positions, operating statuses, diagnostics, etc.). For example, AHU controller 330 may provide BMS controller 366 with temperature measurements from temperature sensors 362-364, equipment on/off states, equipment operating capacities, and/or any other information that can be used by BMS controller 366 to monitor or control a variable state or condition within building zone 306.

Client device 368 may include one or more human-machine interfaces or client interfaces (e.g., graphical user interfaces, reporting interfaces, text-Based computer interfaces, client-facing web services, web servers that provide pages to web clients, etc.) for controlling, viewing, or otherwise interacting with HVAC system 100, its subsystems, and/or devices. Client device 368 may be a computer workstation, a client terminal, a remote or local interface, or any other type of user interface device. Client device 368 may be a stationary terminal or a mobile device. For example, client device 368 may be a desktop computer, a computer server with a user interface, a laptop computer, a tablet, a smartphone, a PDA, or any other type of mobile or non-mobile device. Client device 368 may communicate with BMS controller 366 and/or AHU controller 330 via communications link 372.

Referring now to FIG. 4, a block diagram of a building management system (BMS) 400 is shown, according to some embodiments. BMS 400 may be implemented in building 10 to automatically monitor and control various building functions. BMS 400 is shown to include BMS controller 366 and a plurality of building subsystems 428. Building subsystems 428 are shown to include a building electrical subsystem 434, an information communication technology (ICT) subsystem 436, a security subsystem 438, a HVAC subsystem 440, a lighting subsystem 442, a lift/escalators subsystem 432, and a fire safety subsystem 430. In various embodiments, building subsystems 428 can include fewer, additional, or alternative subsystems. For example, building subsystems 428 may also or alternatively include a refrigeration subsystem, an advertising or signage subsystem, a cooking subsystem, a vending subsystem, a printer or copy service subsystem, or any other type of building subsystem that uses controllable equipment and/or sensors to monitor or control building 10. In some embodiments, building subsystems 428 include waterside system 200 and/or airside system 300, as described with reference to FIGS. 2-3.

Each of building subsystems 428 may include any number of devices, controllers, and connections for completing its individual functions and control activities. HVAC subsystem 440 may include many of the same components as HVAC system 100, as described with reference to FIGS. 1-3. For example, HVAC subsystem 440 may include a chiller, a boiler, any number of air handling units, economizers, field controllers, supervisory controllers, actuators, temperature sensors, and other devices for controlling the temperature, humidity, airflow, or other variable conditions within building 10. Lighting subsystem 442 may include any number of light fixtures, ballasts, lighting sensors, dimmers, or other devices configured to controllably adjust the amount of light provided to a building space. Security subsystem 438 may include occupancy sensors, video surveillance cameras, digital video recorders, video processing servers, intrusion detection devices, access control devices and servers, or other security-related devices.

Still referring to FIG. 4, BMS controller 366 is shown to include a communications interface 407 and a BMS interface 409. Interface 407 may facilitate communications between BMS controller 366 and external applications (e.g., monitoring and reporting applications 422, enterprise control applications 426, remote systems and applications 444, applications residing on client devices 448, etc.) for allowing user control, monitoring, and adjustment to BMS controller 366 and/or subsystems 428. Interface 407 may also facilitate communications between BMS controller 366 and client devices 448. BMS interface 409 may facilitate communications between BMS controller 366 and building subsystems 428 (e.g., HVAC, lighting security, lifts, power distribution, business, etc.).

Interfaces 407, 409 can be or include wired or wireless communications interfaces (e.g., jacks, antennas, transmitters, receivers, transceivers, wire terminals, etc.) for conducting data communications with building subsystems 428 or other external systems or devices. In various embodiments, communications via interfaces 407, 409 may be direct (e.g., local wired or wireless communications) or via a communications network 446 (e.g., a WAN, the Internet, a cellular network, etc.). For example, interfaces 407, 409 can include an Ethernet card and port for sending and receiving data via an Ethernet-Based communications link or network. In another example, interfaces 407, 409 can include a WiFi transceiver for communicating via a wireless communications network. In another example, one or both of interfaces 407, 409 may include cellular or mobile phone communications transceivers. In one embodiment, communications interface 407 is a power line communications interface and BMS interface 409 is an Ethernet interface. In other embodiments, both communications interface 407 and BMS interface 409 are Ethernet interfaces or are the same Ethernet interface.

Still referring to FIG. 4, BMS controller 366 is shown to include a processing circuit 404 including a processor 406 and memory 408. Processing circuit 404 may be communicably connected to BMS interface 409 and/or communications interface 407 such that processing circuit 404 and the various components thereof can send and receive data via interfaces 407, 409. Processor 406 can be implemented as a general purpose processor, an application specific integrated circuit (ASIC), one or more field programmable gate arrays (FPGAs), a group of processing components, or other suitable electronic processing components.

Memory 408 (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present application. Memory 408 may be or include volatile memory or non-volatile memory. Memory 408 may include database components, object code components, script components, or any other type of information structure for supporting the various activities and information structures described in the present application. According to an exemplary embodiment, memory 408 is communicably connected to processor 406 via processing circuit 404 and includes computer code for executing (e.g., by processing circuit 404 and/or processor 406) one or more processes described herein.

In some embodiments, BMS controller 366 is implemented within a single computer (e.g., one server, one housing, etc.). In various other embodiments BMS controller 366 may be distributed across multiple servers or computers (e.g., that can exist in distributed locations). Further, while FIG. 4 shows applications 422 and 426 as existing outside of BMS controller 366, in some embodiments, applications 422 and 426 may be hosted within BMS controller 366 (e.g., within memory 408).

Still referring to FIG. 4, memory 408 is shown to include an enterprise integration layer 410, an automated measurement and validation (AM&V) layer 412, a demand response (DR) layer 414, a fault detection and diagnostics (FDD) layer 416, an integrated control layer 418, and a building subsystem integration later 420. Layers 410-420 may be configured to receive inputs from building subsystems 428 and other data sources, determine optimal control actions for building subsystems 428 Based on the inputs, generate control signals Based on the optimal control actions, and provide the generated control signals to building subsystems 428. The following paragraphs describe some of the general functions performed by each of layers 410-420 in BMS 400.

Enterprise integration layer 410 may be configured to serve clients or local applications with information and services to support a variety of enterprise-level applications. For example, enterprise control applications 426 may be configured to provide subsystem-spanning control to a graphical user interface (GUI) or to any number of enterprise-level business applications (e.g., accounting systems, user identification systems, etc.). Enterprise control applications 426 may also or alternatively be configured to provide configuration GUIs for configuring BMS controller 366. In yet other embodiments, enterprise control applications 426 can work with layers 410-420 to optimize building performance (e.g., efficiency, energy use, comfort, or safety) Based on inputs received at interface 407 and/or BMS interface 409.

Building subsystem integration layer 420 may be configured to manage communications between BMS controller 366 and building subsystems 428. For example, building subsystem integration layer 420 may receive sensor data and input signals from building subsystems 428 and provide output data and control signals to building subsystems 428. Building subsystem integration layer 420 may also be configured to manage communications between building subsystems 428. Building subsystem integration layer 420 translate communications (e.g., sensor data, input signals, output signals, etc.) across a plurality of multi-vendor/multi-protocol systems.

Demand response layer 414 may be configured to optimize resource usage (e.g., electricity use, natural gas use, water use, etc.) and/or the monetary cost of such resource usage in response to satisfy the demand of building 10. The optimization may be Based on time-of-use prices, curtailment signals, energy availability, or other data received from utility providers, distributed energy generation systems 424, from energy storage 427 (e.g., hot TES 242, cold TES 244, etc.), or from other sources. Demand response layer 414 may receive inputs from other layers of BMS controller 366 (e.g., building subsystem integration layer 420, integrated control layer 418, etc.). The inputs received from other layers may include environmental or sensor inputs such as temperature, carbon dioxide levels, relative humidity levels, air quality sensor outputs, occupancy sensor outputs, room schedules, and the like. The inputs may also include inputs such as electrical use (e.g., expressed in kWh), thermal load measurements, pricing information, projected pricing, smoothed pricing, curtailment signals from utilities, and the like.

According to an exemplary embodiment, demand response layer 414 includes control logic for responding to the data and signals it receives. These responses can include communicating with the control algorithms in integrated control layer 418, changing control strategies, changing setpoints, or activating/deactivating building equipment or subsystems in a controlled manner. Demand response layer 414 may also include control logic configured to determine when to utilize stored energy. For example, demand response layer 414 may determine to begin using energy from energy storage 427 just prior to the beginning of a peak use hour.

In some embodiments, demand response layer 414 includes a control module configured to actively initiate control actions (e.g., automatically changing setpoints) which minimize energy costs Based on one or more inputs representative of or Based on demand (e.g., price, a curtailment signal, a demand level, etc.). In some embodiments, demand response layer 414 uses equipment models to determine an optimal set of control actions. The equipment models may include, for example, thermodynamic models describing the inputs, outputs, and/or functions performed by various sets of building equipment. Equipment models may represent collections of building equipment (e.g., subplants, chiller arrays, etc.) or individual devices (e.g., individual chillers, heaters, pumps, etc.).

Demand response layer 414 may further include or draw upon one or more demand response policy definitions (e.g., databases, XML, files, etc.). The policy definitions may be edited or adjusted by a user (e.g., via a graphical user interface) so that the control actions initiated in response to demand inputs may be tailored for the user's application, desired comfort level, particular building equipment, or Based on other concerns. For example, the demand response policy definitions can specify which equipment may be turned on or off in response to particular demand inputs, how long a system or piece of equipment should be turned off, what setpoints can be changed, what the allowable set point adjustment range is, how long to hold a high demand setpoint before returning to a normally scheduled setpoint, how close to approach capacity limits, which equipment modes to utilize, the energy transfer rates (e.g., the maximum rate, an alarm rate, other rate boundary information, etc.) into and out of energy storage devices (e.g., thermal storage tanks, battery banks, etc.), and when to dispatch on-site generation of energy (e.g., via fuel cells, a motor generator set, etc.).

Integrated control layer 418 may be configured to use the data input or output of building subsystem integration layer 420 and/or demand response later 414 to make control decisions. Due to the subsystem integration provided by building subsystem integration layer 420, integrated control layer 418 can integrate control activities of the subsystems 428 such that the subsystems 428 behave as a single integrated super-system. In an exemplary embodiment, integrated control layer 418 includes control logic that uses inputs and outputs from a plurality of building subsystems to provide greater comfort and energy savings relative to the comfort and energy savings that separate subsystems could provide alone. For example, integrated control layer 418 may be configured to use an input from a first subsystem to make an energy-saving control decision for a second subsystem. Results of these decisions can be communicated back to building subsystem integration layer 420.

Integrated control layer 418 is shown to be logically below demand response layer 414. Integrated control layer 418 may be configured to enhance the effectiveness of demand response layer 414 by enabling building subsystems 428 and their respective control loops to be controlled in coordination with demand response layer 414. This configuration may advantageously reduce disruptive demand response behavior relative to conventional systems. For example, integrated control layer 418 may be configured to assure that a demand response-driven upward adjustment to the setpoint for chilled water temperature (or another component that directly or indirectly affects temperature) does not result in an increase in fan energy (or other energy used to cool a space) that would result in greater total building energy use than was saved at the chiller.

Integrated control layer 418 may be configured to provide feedback to demand response layer 414 so that demand response layer 414 checks that constraints (e.g., temperature, lighting levels, etc.) are properly maintained even while demanded load shedding is in progress. The constraints may also include setpoint or sensed boundaries relating to safety, equipment operating limits and performance, comfort, fire codes, electrical codes, energy codes, and the like. Integrated control layer 418 is also logically below fault detection and diagnostics layer 416 and automated measurement and validation layer 412. Integrated control layer 418 may be configured to provide calculated inputs (e.g., aggregations) to these higher levels Based on outputs from more than one building subsystem.

Automated measurement and validation (AM&V) layer 412 may be configured to verify that control strategies commanded by integrated control layer 418 or demand response layer 414 are working properly (e.g., using data aggregated by AM&V layer 412, integrated control layer 418, building subsystem integration layer 420, FDD layer 416, or otherwise). The calculations made by AM&V layer 412 may be based on building system energy models and/or equipment models for individual BMS devices or subsystems. For example, AM&V layer 412 may compare a model-predicted output with an actual output from building subsystems 428 to determine an accuracy of the model.

Fault detection and diagnostics (FDD) layer 416 may be configured to provide on-going fault detection for building subsystems 428, building subsystem devices (i.e., building equipment), and control algorithms used by demand response layer 414 and integrated control layer 418. FDD layer 416 may receive data inputs from integrated control layer 418, directly from one or more building subsystems or devices, or from another data source. FDD layer 416 may automatically diagnose and respond to detected faults. The responses to detected or diagnosed faults may include providing an alert message to a user, a maintenance scheduling system, or a control algorithm configured to attempt to repair the fault or to work-around the fault.

FDD layer 416 may be configured to output a specific identification of the faulty component or cause of the fault (e.g., loose damper linkage) using detailed subsystem inputs available at building subsystem integration layer 420. In other exemplary embodiments, FDD layer 416 is configured to provide “fault” events to integrated control layer 418 which executes control strategies and policies in response to the received fault events. According to an exemplary embodiment, FDD layer 416 (or a policy executed by an integrated control engine or business rules engine) may shut-down systems or direct control activities around faulty devices or systems to reduce energy waste, extend equipment life, or assure proper control response.

FDD layer 416 may be configured to store or access a variety of different system data stores (or data points for live data). FDD layer 416 may use some content of the data stores to identify faults at the equipment level (e.g., specific chiller, specific AHU, specific terminal unit, etc.) and other content to identify faults at component or subsystem levels. For example, building subsystems 428 may generate temporal (i.e., time-series) data indicating the performance of BMS 400 and the various components thereof. The data generated by building subsystems 428 may include measured or calculated values that exhibit statistical characteristics and provide information about how the corresponding system or process (e.g., a temperature control process, a flow control process, etc.) is performing in terms of error from its setpoint. These processes can be examined by FDD layer 416 to expose when the system begins to degrade in performance and alert a user to repair the fault before it becomes more severe.

Referring now to FIG. 5, a block diagram of another building management system (BMS) 500 is shown, according to some embodiments. BMS 500 can be used to monitor and control the devices of HVAC system 100, waterside system 200, airside system 300, building subsystems 428, as well as other types of BMS devices (e.g., lighting equipment, security equipment, etc.) and/or HVAC equipment.

BMS 500 provides a system architecture that facilitates automatic equipment discovery and equipment model distribution. Equipment discovery can occur on multiple levels of BMS 500 across multiple different communications busses (e.g., a system bus 554, zone buses 556-560 and 564, sensor/actuator bus 566, etc.) and across multiple different communications protocols. In some embodiments, equipment discovery is accomplished using active node tables, which provide status information for devices connected to each communications bus. For example, each communications bus can be monitored for new devices by monitoring the corresponding active node table for new nodes. When a new device is detected, BMS 500 can begin interacting with the new device (e.g., sending control signals, using data from the device) without user interaction.

Some devices in BMS 500 present themselves to the network using equipment models. An equipment model defines equipment object attributes, view definitions, schedules, trends, and the associated BACnet value objects (e.g., analog value, binary value, multistate value, etc.) that are used for integration with other systems. Some devices in BMS 500 store their own equipment models. Other devices in BMS 500 have equipment models stored externally (e.g., within other devices). For example, a zone coordinator 508 can store the equipment model for a bypass damper 528. In some embodiments, zone coordinator 508 automatically creates the equipment model for bypass damper 528 or other devices on zone bus 558. Other zone coordinators can also create equipment models for devices connected to their zone busses. The equipment model for a device can be created automatically based on the types of data points exposed by the device on the zone bus, device type, and/or other device attributes. Several examples of automatic equipment discovery and equipment model distribution are discussed in greater detail below.

Still referring to FIG. 5, BMS 500 is shown to include a system manager 502; several zone coordinators 506, 508, 510 and 518; and several zone controllers 524, 530, 532, 536, 548, and 550. System manager 502 can monitor data points in BMS 500 and report monitored variables to various monitoring and/or control applications. System manager 502 can communicate with client devices 504 (e.g., user devices, desktop computers, laptop computers, mobile devices, etc.) via a data communications link 574 (e.g., BACnet IP, Ethernet, wired or wireless communications, etc.). System manager 502 can provide a user interface to client devices 504 via data communications link 574. The user interface may allow users to monitor and/or control BMS 500 via client devices 504.

In some embodiments, system manager 502 is connected with zone coordinators 506-510 and 518 via a system bus 554. System manager 502 can be configured to communicate with zone coordinators 506-510 and 518 via system bus 554 using a master-slave token passing (MSTP) protocol or any other communications protocol. System bus 554 can also connect system manager 502 with other devices such as a constant volume (CV) rooftop unit (RTU) 512, an input/output module (IOM) 514, a thermostat controller 516 (e.g., a TEC5000 series thermostat controller), and a network automation engine (NAE) or third-party controller 520. RTU 512 can be configured to communicate directly with system manager 502 and can be connected directly to system bus 554. Other RTUs can communicate with system manager 502 via an intermediate device. For example, a wired input 562 can connect a third-party RTU 542 to thermostat controller 516, which connects to system bus 554.

System manager 502 can provide a user interface for any device containing an equipment model. Devices such as zone coordinators 506-510 and 518 and thermostat controller 516 can provide their equipment models to system manager 502 via system bus 554. In some embodiments, system manager 502 automatically creates equipment models for connected devices that do not contain an equipment model (e.g., TOM 514, third party controller 520, etc.). For example, system manager 502 can create an equipment model for any device that responds to a device tree request. The equipment models created by system manager 502 can be stored within system manager 502. System manager 502 can then provide a user interface for devices that do not contain their own equipment models using the equipment models created by system manager 502. In some embodiments, system manager 502 stores a view definition for each type of equipment connected via system bus 554 and uses the stored view definition to generate a user interface for the equipment.

Each zone coordinator 506-510 and 518 can be connected with one or more of zone controllers 524, 530-532, 536, and 548-550 via zone buses 556, 558, 560, and 564. Zone coordinators 506-510 and 518 can communicate with zone controllers 524, 530-532, 536, and 548-550 via zone busses 556-560 and 564 using a MSTP protocol or any other communications protocol. Zone busses 556-560 and 564 can also connect zone coordinators 506-510 and 518 with other types of devices such as variable air volume (VAV) RTUs 522 and 540, changeover bypass (COBP) RTUs 526 and 552, bypass dampers 528 and 546, and PEAK controllers 534 and 544.

Zone coordinators 506-510 and 518 can be configured to monitor and command various zoning systems. In some embodiments, each zone coordinator 506-510 and 518 monitors and commands a separate zoning system and is connected to the zoning system via a separate zone bus. For example, zone coordinator 506 can be connected to VAV RTU 522 and zone controller 524 via zone bus 556. Zone coordinator 508 can be connected to COBP RTU 526, bypass damper 528, COBP zone controller 530, and VAV zone controller 532 via zone bus 558. Zone coordinator 510 can be connected to PEAK controller 534 and VAV zone controller 536 via zone bus 560. Zone coordinator 518 can be connected to PEAK controller 544, bypass damper 546, COBP zone controller 548, and VAV zone controller 550 via zone bus 564.

A single model of zone coordinator 506-510 and 518 can be configured to handle multiple different types of zoning systems (e.g., a VAV zoning system, a COBP zoning system, etc.). Each zoning system can include a RTU, one or more zone controllers, and/or a bypass damper. For example, zone coordinators 506 and 510 are shown as Verasys VAV engines (VVEs) connected to VAV RTUs 522 and 540, respectively. Zone coordinator 506 is connected directly to VAV RTU 522 via zone bus 556, whereas zone coordinator 510 is connected to a third-party VAV RTU 540 via a wired input 568 provided to PEAK controller 534. Zone coordinators 508 and 518 are shown as Verasys COBP engines (VCEs) connected to COBP RTUs 526 and 552, respectively. Zone coordinator 508 is connected directly to COBP RTU 526 via zone bus 558, whereas zone coordinator 518 is connected to a third-party COBP RTU 552 via a wired input 570 provided to PEAK controller 544.

Zone controllers 524, 530-532, 536, and 548-550 can communicate with individual BMS devices (e.g., sensors, actuators, etc.) via sensor/actuator (SA) busses. For example, VAV zone controller 536 is shown connected to networked sensors 538 via SA bus 566. Zone controller 536 can communicate with networked sensors 538 using a MSTP protocol or any other communications protocol. Although only one SA bus 566 is shown in FIG. 5, it should be understood that each zone controller 524, 530-532, 536, and 548-550 can be connected to a different SA bus. Each SA bus can connect a zone controller with various sensors (e.g., temperature sensors, humidity sensors, pressure sensors, light sensors, occupancy sensors, etc.), actuators (e.g., damper actuators, valve actuators, etc.) and/or other types of controllable equipment (e.g., chillers, heaters, fans, pumps, etc.).

Each zone controller 524, 530-532, 536, and 548-550 can be configured to monitor and control a different building zone. Zone controllers 524, 530-532, 536, and 548-550 can use the inputs and outputs provided via their SA busses to monitor and control various building zones. For example, a zone controller 536 can use a temperature input received from networked sensors 538 via SA bus 566 (e.g., a measured temperature of a building zone) as feedback in a temperature control algorithm. Zone controllers 524, 530-532, 536, and 548-550 can use various types of control algorithms (e.g., state-based algorithms, extremum seeking control (ESC) algorithms, proportional-integral (PI) control algorithms, proportional-integral-derivative (PID) control algorithms, model predictive control (MPC) algorithms, feedback control algorithms, etc.) to control a variable state or condition (e.g., temperature, humidity, airflow, lighting, etc.) in or around building 10.

BMS with Occupancy Prediction and Equipment Control

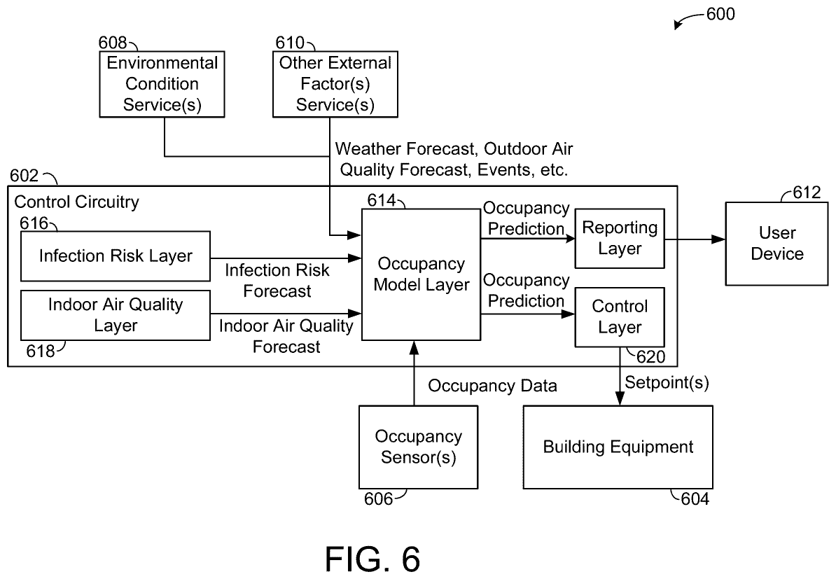

Referring now generally to FIGS. 6-9, systems and methods for generating occupancy predictions and using the occupancy predictions for control of building equipment are shown, according to some embodiments. One observation of the present disclosure is that occupancy in buildings (e.g., commercial buildings such as office buildings, etc.) is a contributor to building energy consumption and domestic water use (i.e., more people use more energy and more water). Variations in occupancy thus creates variations in building energy consumption, water consumption, and/or other resource consumption.

In the context of office buildings and other commercial buildings, variation in occupancy has recently increased and may continue to increase, for example due to the prevalence of remote work or personnel with hybrid roles allowing for both in-office and remote work days. If employees are required to be present in a facility on all work days, occupancy may be relatively well understood from basic schedules, etc., because a building manager can assume that substantially all of the employees will be present on scheduled work days. However, where employees have flexibility to self-select whether to go to a facility on a given day, as one example, the occupancy of the facility on any given day is likely to be more variable. As an effect of such variability, building energy consumption, water usage, other resource usage, etc. may also be more variable. Accordingly, providing modeling and/or control features relating to building equipment and resource usage may benefit from accurate occupancy predictions.

One aspect of the present disclosure is a recognition that occupancy of a facility may be affected by a variety of factors, including external environmental factors and according to complexed, nuanced relationships. For example, occupancy may be driven down by inclement weather (rain, snow, wind, hurricanes, tornados, lightening, sandstorm, etc.) or poor outdoor air quality (e.g., high particulate counts, pollution, outdoor allergens, airborne diseases, etc.) which discourages personnel from traveling to the facility, but may also be driven down by ideal weather or good outdoor air quality which may draw people away from work (e.g., for recreational purposes). As another example, natural events such as forest fires, earthquakes, landslides, tsunamis, volcanic eruptions, etc. may also have an effect on occupancy (e.g., by obstructing travel to a facility). As another example, large community events or happenings (e.g., political events, festivals, sporting events, construction projects, etc.) may affect occupancy (e.g., by affecting traffic, by increasing the likelihood of employees taking a day off, etc.). As yet another example, infection risk (either internal to the building or in the external community) may affect occupancy, as personnel may be less likely to enter the facility if the infection risk is high (e.g., due to community spread of a transmissible disease, etc. as described below). Indoor air quality at the facility may also be a related factor. These and other factors contribute to occupancy. Accordingly, a sophisticated, technological modeling process may be advantageous for handling such relationships in a manner that enables reliable occupancy predictions which can be used in control of building equipment. For example, the systems and methods described herein can outperform models based solely on past occupancy patterns (e.g., models which do not consider at least one of the factors mentioned above).

As an example, consider a scenario in which tomorrow is a scheduled working day and typically people would go to the office; however, a weather forecast has predicted that most likely there will be a heatwave (or blizzard, sandstorm, etc.) such that most people would choose to work from home. Without the innovations herein, a conventional occupancy schedule or forecast would not account for such a sudden change, for example because the weather forecast would not be used as an input, and would therefore indicate to a building manager to still apply the usual building operations for a fully-occupied work day. However, such an approach may waste energy and/or other resources or provide uncomfortable building conditions, due to the effects of educed occupancy. Predicting such an occupancy reduction using the teachings herein can enable building equipment to be controlled accordingly, such that energy and other resource usage can be appropriately tuned to occupancy as discussed in detail below.

As another example, consider a scenario in which City A is experiencing a disease outbreak, such that infection risk is relatively high. Results of infection risk modeling may show a relatively high infection risk, such that many employees choose to work remotely due to the infection risk or are working remotely due to having been infected. If a building system uses an occupancy schedule or prediction which does not account for such external factors, occupancy may be over-estimated for a given day and selected control settings, etc. may result in overuse of energy and/or other resources. Predicting occupancy based on infection risk, as taught herein, can enable building operations to automatically adapt to adjust for corresponding changes in occupancy tied to disease outbreaks, pandemics, epidemics, periods of high transmission, etc.

Referring now to FIG. 6, a system 600 enabled to predict occupancy and control building equipment based on occupancy predictions is shown, according to some embodiments. The system 600 can be implemented as part of, can interoperate with, etc. the BMS 300, BMS 400, and/or BMS 500 described above, in various embodiments. The system 600 is shown as including control circuitry 602 communicable with building equipment 604, one or more occupancy sensors 606, one or more environmental condition services 608, other external factor(s) service(s) 610, and a user device 612. The control circuitry 602 can include elements implemented using various combinations of one or more processors and instructions and data stored on one or more non-transitory computer-readable media, with the elements of the control circuitry 602 shown as an occupancy model layer 614 that receives inputs form an infection risk layer 616 of the control circuitry 602 and an indoor air quality layer 618 of the control circuitry 602 and provides an output to the control layer 620 of the control circuitry 602 and to a reporting layer 621 of the control circuitry 602. In some embodiments, the control circuitry 602 is implemented as part of building enterprise manager, for example in a cloud-based computing resource remote form the building equipment 604, for example as part of OpenBlue by Johnson Controls.

The building equipment 604 may include HVAC equipment (e.g., airside and/or waterside equipment as described above), central plant equipment, lighting equipment, plumbing equipment (e.g., water heater, pumps, etc.), energy storage equipment (e.g., battery, thermal energy storage), and/or other building equipment in various embodiments. The building equipment 604 may be operable to affect a variables state or condition of a building (e.g., temperature, humidity, airflow, pressure, indoor air quality, etc.) and may consume energy and/or other resources (e.g., water, natural gas), in some embodiments. As shown in FIG. 1, the building equipment 604 operates in accordance with one or more setpoints provided by the control circuitry 602 (e.g., a temperature setpoint, an airflow setpoint, a power setpoint, a valve position setpoint).

The one or more occupancy sensors 606 are configured to provide data indicative of the occupancy of the space. In some embodiments, the data indicates whether the space is occupied or unoccupied (e.g., binary values). In some embodiments, the data indicates a number of occupants in the space. Different types of occupancy sensors 606 may be included in various embodiments. For example, the occupancy sensors 606 may be access control devices (e.g., RFID readers, door ajar sensors) enabled to count individuals entering and/or leaving a space (e.g., based on detecting RFID tags of such individuals, based on counting opening of a door, etc.). As another example, the occupancy sensors 606 may be motion detectors positioned in a space. As another example, the occupancy sensors 606 may be cameras (e.g., thermal camera), for example combined with video and/or image processing adapted to determine a number of people visible in a space. One or more types of occupancy sensors 606 can be included in various embodiments. The one or more occupancy sensors 606 can thereby measure occupancy of a space and provide such occupancy data to the control circuitry 602 (e.g., to occupancy model layer 614).

The environmental condition service(s) 608 is/are configured to provide one or more forecasts of environmental conditions of the environment outside a facility/building. The environmental condition service(s) 608 may include a weather forecasting service that provides a weather forecast to the control circuitry 602 (e.g., to occupancy model layer 602), with the weather forecast indicating predicted values of outdoor air temperature, outdoor air humidity, precipitation likelihood or rates, wind speed, cloud cover, and/or other outdoor condition in various embodiments. The environmental condition service(s) 608 may include an outdoor air quality service configured to provide outdoor air quality information, for example current or forecast values of outdoor air quality (e.g., particulate concentrations, ozone levels, etc.). The environmental condition service(s) 608 can be third party services, cloud-based services, etc., for example communicable with the control circuitry 602 via the Internet. In some embodiments, the environmental condition service(s) 608 can provide historical/actual values of environment conditions (e.g., measured temperatures, etc.), in addition or alternative to forecasts.

The other external factor(s) service(s) 610 is/are configured to provide forecasts of one or more other external factors which may affect facility occupancy. In some embodiments, the other external factor(s) service(s) 610 can provide information relating to natural events other than weather, for example relating to forest fires, earthquakes, landslides, volcanic eruptions, etc., for example information relating to the location or effects of such events (e.g., a projection that a forest fire will become proximate to a facility). In some embodiments, other external factor(s) service(s) 610 provide a schedule of community events (e.g., festivals, sporting events, political rallies, major construction projects, transportation industry employee strikes, etc.) which may affect transportation options, traffic, etc. and/or otherwise influence occupancy. The other external factor(s) service(s) 610 The other external factor(s) service(s) 610 can be third party services, cloud-based services, etc., for example communicable with the control circuitry 602 via the Internet. The other external factor(s) service(s) 610 and the environmental condition service(s) 608 can thus combine to provide, to the control circuitry 602, forecasts of various conditions external to a facility which may influence occupancy of the facility. In some embodiments, the other external factor(s) service(s) 610 can provide historical/actual data of such external factors, in addition or alternative to forecasts.

The control circuitry 602 is configured to include an infection risk layer 616. The infection risk layer 616 is configured to generate an infection risk forecast shown as being provided to the occupancy model layer 614 in FIG. 6. In some embodiments, the infection risk forecast is generated using any of the clean air optimization methods or infection risk modeling methods described in U.S. Pat. No. 11,269,306 granted Mar. 8, 2022, U.S. Pat. No. 11,131,473 granted Sep. 28, 2021, U.S. patent application Ser. No. 17/403,669 filed Aug. 16, 2021, U.S. patent application Ser. No. 17/483,078 filed Sep. 23, 2021, U.S. patent application Ser. No. 17/826,635 filed May 27, 2022, U.S. patent application Ser. No. 17/459,963 filed Aug. 27, 2021, and/or U.S. patent application Ser. No. 17/476,351 filed Sep. 15, 2021, the entire disclosures of which are incorporated by reference herein. The infection risk forecast may be facility-specific and generate by the control circuitry 602 for a particular building, for example based on a floor plan of the building, ventilation design and equipment for the building, filtration available in the building, etc. as described in the above-incorporated reference.

In some embodiments, the infection risk forecast is based on a default occupancy of the building (e.g., an average occupancy, a typical occupancy for a normal occupied day, etc.), thereby indicating the infection risk associated with a scenario where occupants occupy a facility in a normal manner (e.g., despite a disease outbreak). Such an infection risk may sufficiently correspond to the perceived risk which causes such occupants to, in some instances, avoid occupying the facility, even if not accurately reflecting actual risk associated with lower occupancy in the event that occupants decide to not enter the facility due to the perceived infection risk. The infection risk forecast can be provided by the infection risk layer 616 as one or more quantified values of infection risk (e.g., scale of zero to one) for an upcoming time period, for example a timeseries of infection risk values indicating the infection risk at each time step in the upcoming time period.

The indoor air quality layer 618 of the control circuitry 602 is configured to provide an air quality forecast to the occupancy model layer 614. In some embodiments, the air quality forecast is generated using any of the clean air optimization methods or air quality prediction methods described in any of the patent applications or patents incorporated by reference above. The indoor air quality forecast may be facility-specific and generated by the control circuitry 602 for a particular building, for example based on a floor plan of the building, ventilation design and equipment for the building, filtration available in the building, etc. as described in the above-incorporated reference. The indoor air quality forecast may indicate predicted values of one or more air quality conditions such as particulate concentration, carbon dioxide level, etc.

Like the infection risk forecast, the indoor air quality forecast may be based on a default or baseline occupancy estimate of the building under normal conditions. However, it is contemplated that the occupancy estimate used by the infection risk layer 616 and the indoor air quality layer 618 to generate the infection risk forecast and the indoor air quality forecast can be updated based on the occupancy prediction generated by the occupancy model layer 614. The updated occupancy can then be provided as an input to the infection risk layer 616 and the indoor air quality layer 618 to generate updated infection risk forecasts and updated indoor air quality forecasts, which in turn may affect the occupancy prediction generated by the occupancy model layer 614. In some embodiments, this process can be repeated (e.g., recursively) until the occupancy prediction generated by the occupancy model layer 614 and the occupancy estimates used by the infection risk layer 616 and the indoor air quality layer 618 have substantially converged. For example, if the occupancy prediction generated by the occupancy model layer 614 deviates from the occupancy estimate used as an input to the infection risk layer 616 and the indoor air quality layer 618 to generate the infection risk forecast and the indoor air quality forecast by an amount that exceeds a threshold, the control circuitry 602 may determine that convergence has not yet been achieved and may trigger another iteration of the process using the updated occupancy prediction as an input to the infection risk layer 616 and the indoor air quality layer 618. Conversely, if the occupancy prediction generated by the occupancy model layer 614 is within a threshold around the occupancy estimate used as an input to the infection risk layer 616 and the indoor air quality layer 618 to generate the infection risk forecast and the indoor air quality forecast, the control circuitry 602 may determine that convergence has been achieved. In this way, the control circuitry 602 can ensure that the occupancy prediction generated by the occupancy model layer 614 information used and generated by occupancy model layer 614, the infection risk layer 616, and the indoor air quality layer 618 is consistent.

The occupancy model layer 614 thereby receives inputs from one or more of the environmental condition service(s) 608, the other external factor(s) service(s) 610, the infection risk layer 616, and/or the indoor air quality layer 618, in various embodiments. In various embodiments, any combination of such inputs can be used by the occupancy model layer 614 as inputs to a model which predicts occupancy of a space, and any such inputs can be omitted in various embodiments. The occupancy model layer 614 is configured to predict occupancy of a space (facility, building, room, floor, area, etc.) based on such inputs.

In some embodiments, a predicted occupancy provided by the occupancy model layer 614 indicates whether a space is expected to be occupied or unoccupied (e.g., binary values). In some embodiments, the predicted occupancy provided by the occupancy model layer 614 indicates a predict number of occupants. The predicted occupancy from the occupancy model layer 614 can be a single value for a future time period (e.g., for a next day) or may be a time series includes a value for each time in an upcoming time period (e.g., a value for each half-hour of the next two days).

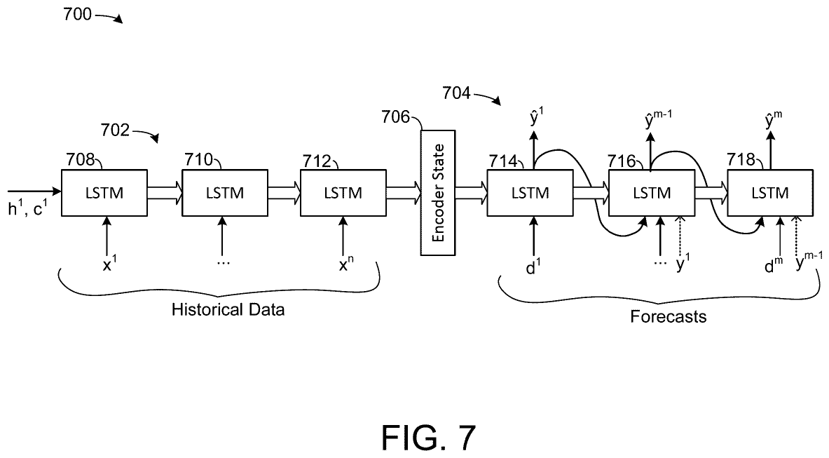

In some embodiments, the occupancy model layer 614 predicts occupancy using an artificial intelligence model, for example a machine learning model such as an artificial neural network. An example of such a model is shown in FIG. 7 and described in detail below with reference thereto. The model may be trained on data of historical conditions and occupancy, for example training data indicating occupancy values for a facility at past times and values of the various inputs (e.g., weather values, event information, air quality values, infection risk values) at such past times. A machine-learning approach can be used based on such training data to tune parameters, weights, etc. of a model to enable the model to output the occupancy values based on the corresponding input values. In some embodiments, the machine-learning approach uses a transfer learning approach, whereby an initial model is taken from a model trained for another facility or set of facilities and tuned to use for a specific facility based on data for the specific facility, enabling model training where only limit facility-specific data is available.

In some embodiments, the occupancy model layer 614 may be adapted to update the model, for example in a reinforcement learning approach whereby the model applied is updated over time based on differences between occupancy predictions generated by the occupancy model layer 614 and occupancy data from the one or more occupancy sensors 606. The occupancy model may thereby improve over time as more data becomes available. The occupancy model may thereby also adapted overtime as occupant behaviors change (e.g., as occupants become more or less influenced by different factors to attend or not attend the facility).

In some embodiments, the occupancy model layer 614 uses multiple occupancy models for a given facility, for example for a multi-tenant building (e.g., a large office building leasing office space to multiple companies). Using multiple models may allow the occupancy model layer 614 to account for different behavior of different groups of people who use the facility (e.g., differences between different tenants of the same building, differences between employees and customers of an entity operating in a building, etc.). A sum of predicted occupancies of such models can be used to provide an overall occupancy prediction for a building, in such embodiments.

As shown in FIG. 6, the occupancy model layer 614 provides the occupancy prediction to control layer 620. Control layer 620 is configured to provide one or more setpoints to the building equipment 604 based on the occupancy prediction, such that the control circuitry 602 controls the building equipment based on the occupancy prediction. The control layer 620 can uses the occupancy prediction as an input to various control approaches in various embodiments.

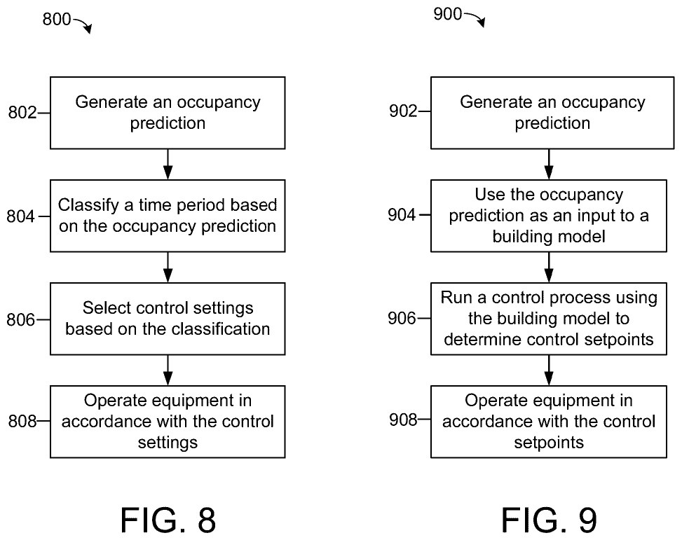

In some embodiments, for example as shown in FIG. 8 and described in detail below with reference thereto, the control layer 620 is configured to classify a time period based on the occupancy prediction (e.g., as a high-occupancy time period, as a low-occupancy time period, as a zero-occupancy time period) and select one or more setpoints for the building equipment based on such a classification. In such embodiments, the control layer 620 may pre-store settings associated with each possible classification.

In some embodiments, for example as shown in FIG. 9 and described in detail with reference thereto, the control layer 620 is configured to use the occupancy prediction as input to a building model and generate one or more setpoints for the building equipment by running an optimization that uses the building model. Such an approach may use the occupancy prediction to improve predictions of building temperature (e.g., due to effects of occupant body heat and other activities on indoor air temperature), other indoor conditions, and/or energy or other resource usage, which in turn can improve solutions reached by an optimization process that use such predictions.

The building equipment 604 can thus be operated based on the occupancy predictions generated by the occupancy model layer 614. As one example, a building may be pre-cooled in the morning before the building reaches its highest occupancy for a given day, such that pre-cooling decisions must be made before the days actual occupancy can be measured. For high-occupancy days, a relative large amount of pre-cooling may be required to maintain comfortable conditions during the day (due to heat load from occupants), at relatively high energy usage. For low-occupancy data, a relatively small amount of pre-cooling may be required to maintain the substantially the same conditions, at relatively lower energy usage. By accurately predicting whether the upcoming day will be a high occupancy day or a low occupancy day, the appropriate amount of pre-cooling can be provided. This approach can save energy usage (e.g., when the occupancy model layer 614 predicts low occupancy but a conventional schedule would indicate higher occupancy) and/or improve occupant comfort (e.g., when the occupancy model layer 614 predicts high occupancy but a conventional schedule would indicate lower occupancy). Various such examples are enabled by the teachings herein. Overall equipment performance and building system performance is thereby improved by controlling the building equipment 604 in accordance with occupancy predictions as taught herein.

The occupancy model layer 614 also provides the occupancy prediction to reporting layer 621. The reporting layer 621 can use the occupancy prediction to generate one or more reports (e.g., dashboards, visualizations, scorecards, etc.) relating to building system performance, and cause the one or more reports to be provided to a user via the user device 612 (which may be a smartphone, personal computer, client device 504, client device 448, etc.). In some embodiments, the reporting layer 621 applies the occupancy prediction as an input to a building model configured to predict energy usage, water usage, or other resource usage over a time period and generates a report showing such a prediction. Such predictions can be used to show progress towards energy savings goals, validate that goals are achieved, enable operators to monitor and manage building operations, etc. The reporting layer 621 can provide various features as described above with respect to monitoring and reporting applications 4222, automated measurement and validation layer 423, fault detection and diagnostic layer 416, and/or other building monitoring and diagnostic applications described herein. The occupancy predictions taught herein enable such monitoring and reporting applications to improve in accuracy and/or to be enhanced with additional insights by accounting for the effects of occupancy on building system behavior and performance.

Referring now to FIG. 7, a block diagram of an occupancy model 700 is shown, according to some embodiments. The occupancy model 700 may be provided by (included in, used by, etc.) the occupancy model layer 614, in some embodiments.

In the embodiment shown, the occupancy model 700 has an encoder-decoder architecture and includes a plurality of long short-term memory networks or layers (LSTMs). The occupancy model 700 is shown as including an encoder 702 and a decoder 704, with the encoder 702 providing an encoder state 706 to the decoder 704.

In the example shown, the encoder 702 includes n LSTM layers (i.e., any number n, e.g., three, four, five, etc.). Each LSTM layer may be associated with a different time step for which historical data is being taken as an input. For example, a first LSTM 708 may be associated with t−n (in the example shown where n=3, three units of time before a current time) and may receive historical values of occupancy (e.g., occupancy numbers or status of the building at t−n), weather (e.g., outdoor air temperature, precipitation amount, etc. at t−n), historical infection risk at −3, and/or values for other variables such as r outdoor air quality, indoor air quality, other event information, etc. corresponding to that time step in the past (i.e., t−n in this example), in various embodiments. A second LSTM 710 may be associated with a next time step (e.g., t−2), and third LSTM 712 may be associated with yet another time step (e.g., t−1) with each LSTM (e.g., LSTM 710, LSTM 712) of the encoder 702 receiving the values that were reached by the input variables at the corresponding historical time steps. Historical values of the input variables are thereby used as inputs which can influence occupancy predictions. The LSTMs 708-712 of the encoder 702 combine to generate the encoder state 706 which can be characterized as a summary of the input information weighted and formatted as suitable as an input to the decoder 704. In other embodiments, the encoder 702 is provided as a single LSTM network.

The decoder 704 is configured to generate an output sequence, for example defining occupancy predictions for a plurality of future time steps. The decoder 704 is shown as including m LSTMs (i.e., any number m of LSTMs, e.g., two, three, four, five, etc.). The decoder can use forecasts of weather, air quality, infection risk, events, etc. (e.g., as described as inputs to the occupancy model layer 614) as inputs, shown in in FIG. 7 as d¹, . . . , d^{m}, as well as using the encoder state 706 from the encoder 702. As shown in FIG. 7, a fourth LSTM 714 can receive input d¹ and generate a first occupancy prediction ŷ¹. The first occupancy prediction ŷ¹ is provided from the fourth LSTM 714 to a fifth LSTM 716 which also receives an input d². The fifth LSTM 716 uses such information to generate a second occupancy prediction ŷ², with FIG. 7 illustrating that various embodiments can be repeated such that the fifth LSTM 716 (or some subsequent LSTM) provides an occupancy prediction denoted as ŷ^{m-1}. FIG. 7 shows a sixth LSTM 718 (e.g., the m^{th} LSTM) receiving the prior occupancy prediction ŷ^{m-1} and an input (e.g., forecast value(s)) d^{m} and generating occupancy forecast ŷ^{m}. A series of outputs ŷ¹, ŷ², . . . , ŷ^{m} is thereby produced as an output of the model 700. In other embodiments, the decoder 704 is provided as a single LSTM network.

FIG. 7 further illustrates that, in a training phase, the fifth LSTM 716 and the sixth LSTM 718 can receive actual occupancy values (e.g., as is available in the training data), denoted as y¹ and y^{m-1}. The model 700 uses such values to train the LSTM 716 and LSTM 718 to make more accurate occupancy predictions (e.g., by adjust weights, parameters, etc. to minimize prediction error). An artificial intelligence model which provides occupancy predictions based on the various inputs described herein can thereby be provided.

Referring now to FIG. 8, a flowchart of a process 800 for controlling building equipment based on an occupancy prediction is shown, according to some embodiments. The process 800 can be executed by the control circuitry 602, in some embodiments. The process 800 can use the model 700, in some embodiments.

At step 802, an occupancy prediction is generated. The occupancy prediction may be generated based on one or more inputs selected from a group including weather forecasts (e.g., temperature, wind, precipitation), natural events information (e.g., forest fire forecasts, outdoor air quality forecasts, information about other natural events), community event schedules, news (e.g., current events, political events, war, etc.), infection risk forecast, and indoor air quality forecast, in various embodiments. Step 802 can include applying an artificial intelligence model, machine learning model, artificial neural network, etc., for example an encoder-decoder model using an LSTM approach as shown in FIG. 7 and described with reference thereto. The occupancy prediction generated in step 802 can indicate whether a facility is predicted to be occupied during an upcoming time period, indicate a predicted level of occupancy for the upcoming time period (e.g., low, medium, high), or indicate a predicted number of occupants for the upcoming time period. The occupancy prediction may be singular (e.g., one value for an entire day) or may indicate different values, etc. for different time steps in an upcoming time period, for example a value for each half-hour of the next day.

At step 804, a time period is classified based on the occupancy prediction. Possible classifications can include occupied, unoccupied, work day, vacation day, holiday, low occupancy day, high occupancy day, late arrival day, early departure day, etc., among other possibilities which characterize different types of building occupancy that might occur. Each possible classification may be mapped to a set of occupancy predictions which fall within such a classification, and step 804 can include using such a mapping to determine the classification of the time period. In some examples, the mappings provide threshold values comparable to occupancy predictions to classify a day based on whether a predicted number of occupants exceeds a threshold. In some examples, the classified time period is an entire day while occupancy predictions are made for time steps within the day, such that a profile of occupancy predictions over the course of the day is used to classify a day (e.g., a day can be classified as a late arrival day if predicted occupancy is lower than usual in the morning but increases later (e.g., due to a morning snowstorm represented in weather data input to a predictive model used in step 802)). Various logic for classifying a time period (e.g., day) based on occupancy prediction can be applied. Step 804 thereby outputs a classification (label, etc.) for an upcoming time period.

At step 806, one or more control settings (e.g., setpoints) are selected based on the classification. For example, each classification can be associated with a set of settings (e.g., predefined, stored in a look-up table, etc.) for building equipment (e.g., building equipment 604). The settings can include indoor temperature setpoints, lighting levels, airflow setpoints, amounts of energy or other resource to be provided, consumed, or stored by building equipment, fan speeds, valve positions, damper positions, etc. in various embodiments. The settings may be arranged in a schedule for the associated time period (e.g., a profile of temperature values over time period). In some embodiments, the control settings indicate different control logic, rules, etc. to apply for different classification (e.g., a simple feedback control may be provided for one classification while a model predictive control or other advanced algorithmic control is used for another classification). The classification based on occupancy prediction is thereby used to define control settings for a time period.

In some scenarios, the one or more control settings are selected in order to prepare a building for the predicted occupancy level, for example to increase cooling on a hot day if high occupancy is expected (e.g., pre-cooling a space in anticipation of high occupancy). Accordingly, the one or more control settings may be for building equipment that operate to affect a state or condition of a building space for which occupancy is predicted. In some embodiments, at least a subset of the one or more control settings may be for a different building, different equipment, other system, etc., for example such that process 800 can reduce consumption of a different building or equipment if high consumption associated with high occupancy is predicted for a given building or vice versa. Such an approach can enable use of occupancy predictions for consumption balancing across an enterprise to facilitate achievement of resource (energy) consumption or carbon emissions goals (e.g., net zero goals).

At step 808, building equipment is operated in accordance with the control settings selected in step 806. Operating the equipment in accordance with the control settings can include causing HVAC equipment to heat, ventilate, or cool the facility as indicated by the control settings (e.g., to achieve a temperature setpoint of the selected control settings), for example. Operating the equipment in accordance with the control settings can include turning on or off lights in a facility based on the control settings, for example. Various such examples are possible. Advantageously, operation of the building is executed in a manner which anticipates building occupancy on a particular day based on holistic predictions, which can enable building operations to improve comfort, reduce infection risk, improve air quality, etc. in an efficient manner tailored to facility occupancy. Such a proactive approach may provide better results (e.g. more comfort, less infection risk, better air quality) at lower energy consumption and/or cost as compared to approaches based on static occupancy schedules or reactive approaches based measured occupancy.

Referring now to process 900, another process for controlling building equipment based on occupancy predictions is shown, according to some embodiments. The process 900 can be executed by the control circuitry 602, in some embodiments. The process 900 can use the model 700, in some embodiments.

At step 902, an occupancy prediction is generated. The occupancy prediction may be generated based on one or more inputs selected from a group including weather forecasts (e.g., temperature, wind, precipitation), natural events information (e.g., forest fire forecasts, outdoor air quality forecasts, information about other natural events), community event schedules, news (e.g., current events, political events, war, etc.), infection risk forecast, and indoor air quality forecast, in various embodiments. Step 902 can include applying an artificial intelligence model, machine learning model, artificial neural network, etc., for example an encoder-decoder model using an LSTM approach as shown in FIG. 7 and described with reference thereto. The occupancy prediction generated in step 902 can indicate whether a facility is predicted to be occupied during an upcoming time period, indicate a predicted level of occupancy for the upcoming time period (e.g., low, medium, high), or indicate a predicted number of occupants for the upcoming time period. The occupancy prediction may be singular (e.g., one value for an entire day) or may indicate different values, etc. for different time steps in an upcoming time period, for example a value for each half-hour of the next day.

At step 904, the occupancy prediction is used as an input to a building model. The building model may be configured to model one or more building conditions (e.g., indoor air temperature, heat transfer) and/or resource usage of building equipment (e.g., energy consumption, water consumption, etc.) over an upcoming time period based on the occupancy prediction. In some embodiments, the occupancy prediction is used for feedforward energy flow estimations, for example for feedforward control and/or combined feedback and feedforward control as described in U.S. application Ser. No. 17/181,847, filed Feb. 22, 2021, the entire disclosure of which is incorporated by reference herein in its entirety. In some embodiments, the occupancy prediction is used to contribute to heat disturbance modeling as part of a building thermal model, for example models as in U.S. application Ser. No. 16/719,469, filed Dec. 18, 2019, the entire disclosure of which is incorporated by reference herein.

At step 906, a control process is run using the building model to determine control setpoints. The control process may be a combined feedforward-feedback control process as described in U.S. application Ser. No. 17/181,847, filed Feb. 22, 2021, the entire disclosure of which is incorporated by reference herein in its entirety. The control process may be a model predictive control process, for example including performing an optimization of an objective function that characterizes resource usage, carbon emissions, pollution, costs, etc. using the building model. For example, the control process may be as described in in U.S. application Ser. No. 16/719,469, filed Dec. 18, 2019, U.S. Pat. No. 11,274,849, filed Sep. 30, 2019, U.S. patent application Ser. No. 17/826,916, filed May 27, 2022, and/or U.S. patent application Ser. No. 17/826,921, filed May 27, 2022, the entire disclosures of which are incorporated by reference herein in their entireties. Use of occupancy prediction can improve the accuracy and reliability of a building model (e.g., of predictions by such a model of building temperature or equipment energy usage resulting from the building be occupied to the predicted extent), such that control settings determined by a control process in step 906 can be better (e.g., more optimal, more efficient, better suited to provide desired building conditions) as compared to approaches which do not use occupancy predictions. For example, such processes can provide for carbon emissions optimization, achievement of net-zero energy consumption, or the like, for example as described in U.S. Patent Publication No. 2023/0020417 published Jan. 19, 2023, the entire disclosure of which is incorporated by reference herein.

In some embodiments, the occupancy prediction can be used as an input to a control process in which occupancy of building spaces is a decision variable to be selected by the control process (e.g., in an optimization process). For example, an occupancy prediction for a building can be used as a constraint on an optimization process that allocates the predicted number of occupants across spaces of the building (floors, rooms, etc.), for example as described in U.S. patent application Ser. No. 18/219,008 filed Jul. 6, 2023, the entire disclosure of which is incorporated by reference herein in its entirety.

At step 908, equipment is operated in accordance with the control setpoints from step 906. Operating the equipment in accordance with the control settings can include causing HVAC equipment to heat, ventilate, or cool the facility as indicated by the control settings (e.g., to achieve a temperature setpoint of the selected control settings), for example. Operating the equipment in accordance with the control settings can include turning on or off lights in a facility based on the control settings, for example. Various such examples are possible.

Advantageously, operation of the building is executed in a manner which anticipates building occupancy on a particular day based on holistic predictions, which can enable building operations to improve comfort, reduce infection risk, improve air quality, etc. in an efficient manner tailored to facility occupancy. Such a proactive approach may provide better results (e.g. more comfort, less infection risk, better air quality) at lower energy consumption and/or cost as compared to approaches which are agnostic to occupancy, based on static occupancy schedules or reactively based measured occupancy.

### Configuration of Exemplary Embodiments

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products including machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

What is claimed is:

1. A method for controlling building equipment, comprising:
providing an occupancy prediction for a building using an occupancy prediction model that uses both historical values and forecast values of an environmental condition as inputs; and
controlling the building equipment based on the occupancy prediction.

2. The method of claim 1, wherein providing the occupancy prediction comprises:
generating, by at least one first neural network, an encoder state based on historical timeseries data of occupancy and the environmental condition as inputs;
generating, by a second neural network, the occupancy prediction based on the encoder state and a forecast timeseries for the environmental condition.

3. The method of claim 2, wherein the at least one first neural network comprises a long-short-term-memory network receiving a plurality of values of the occupancy and a plurality of values of the environmental condition from the historical timeseries data as inputs.

4. The method of claim 2, wherein the at least one second neural network comprises a long-short-term-memory network receiving the encoder state and a plurality of values of the environmental condition from the forecast timeseries as inputs.

5. The method of claim 2, wherein the forecast timeseries for the environmental condition comprises weather values associated with a plurality of time steps and the occupancy prediction comprises a plurality of occupancy values associated with the plurality of time steps.

6. The method of claim 1, wherein providing the occupancy prediction comprises:
using a first value of the occupancy prediction to generate an infection risk estimate for the building; and
using the infection risk estimate to generate a second value of the occupancy prediction.

7. The method of claim 1, wherein the environmental condition is a particulate matter concentration or air quality index.

8. The method of claim 1, wherein the environmental condition is precipitation.

9. The method of claim 1, wherein the occupancy predication comprises a timeseries of predicted occupancy values for a plurality of time steps of an upcoming time period.

10. The method of claim 1, wherein controlling the building equipment based on the occupancy prediction comprises classifying a time period into a classification based on the occupancy prediction, selecting control settings based on the classification, and controlling the building equipment using the control settings.

11. The method of claim 1, wherein controlling the building equipment based on the occupancy prediction comprises using the occupancy prediction as an input to a predictive building model and generating a setpoint for the building equipment by performing an optimization using the predictive building model.

12. One or more non-transitory computer-readable media storing instructions that, when executed by one or more processors, cause the one or more processors to perform operations comprising:
predicting a future occupancy of a space by using forecasted values relating to infection risk and weather as inputs to an occupancy model; and
controlling building equipment to affect heating, ventilation, or cooling of the space based on the future occupancy of the space.

13. The one or more non-transitory computer-readable media of claim 12, wherein the occupancy model comprises a plurality of artificial neural networks.

14. The one of more non-transitory computer-readable media of claim 12, wherein the occupancy model comprises a long short-term memory network and has an encoder-decoder architecture.

15. The one or more non-transitory computer-readable media of claim 12, the operations further comprising using historical occupancy measurements as inputs to the occupancy model.

16. The one or more non-transitory computer-readable media of claim 12, wherein predicting the future occupancy of the space further comprises using information indicative of an event occurring external to the space.

17. The one or more non-transitory computer-readable media of claim 12, the operations further comprising training the occupancy model on historical occupancy data, infection risk history, and weather measurements.

18. The one or more non-transitory computer-readable media of claim 12, wherein controlling building equipment based on the future occupancy of the space comprises:
determining a classification of a time period as occupied or unoccupied based on the future occupancy; and
selecting a setting for the building equipment based on the classification.

19. The one or more non-transitory computer-readable media of claim 12, wherein controlling the building equipment based on the future occupancy of the space comprises applying the future occupancy as an input to a building model and using the building model for model predictive control.

20. The one or more non-transitory computer-readable media of claim 12, wherein the forecasted values relating to weather are indicative of precipitation or air quality index.
